(19) United States
(12) Patent Application Publication
(10) Pub. No.: US 2023/0333419 A1
(43) Pub. Date: Oct. 19, 2023

(54) VIEWING ANGLE SWITCHING MODULE AND DISPLAY APPARATUS

(71) Applicant: HannStar Display Corporation, Taipei City (TW)

(72) Inventors: Chun Yen Lai, Tainan City (TW); Wei-Chih Hsu, Taichung City (TW); Yen-Chung Chen, Taichung City (TW)

(73) Assignee: HannStar Display Corporation, Taipei City (TW)

(21) Appl. No.: 18/081,696

(22) Filed: Dec. 15, 2022

(30) Foreign Application Priority Data
Apr. 13, 2022 (CN) 202210385559.5

(51) Int. Cl. G02F 1/13; G02F 1/1335; G02F 1/1337

(52) U.S. Cl. CPC G02F 1/1323; G02F 1/133531; G02F 1/133769

(57) ABSTRACT

A viewing angle switching module includes a first viewing angle controlling device, a second viewing angle controlling device, a first polarizer, and a second polarizer. The first viewing angle controlling device includes a first alignment layer, a second alignment layer, and a first liquid crystal layer. The second viewing angle controlling device includes a third alignment layer, a fourth alignment layer, and a second liquid crystal layer. The first polarizer is disposed on a side of the first viewing angle controlling device, and an axial direction of a first absorption axis thereof is perpendicular or parallel to a first alignment direction of the first alignment layer. The second polarizer is disposed on a side of the second viewing angle controlling device, and an axial direction of a second absorption axis thereof is perpendicular or parallel to a third alignment direction of the third alignment layer. A display apparatus including the same is also disclosed.

### CROSS-REFERENCE TO RELATED APPLICATION

This application claims the priority benefit of Chinese application no. 202210385559.5, filed on Apr. 13, 2022. The entirety of the above-mentioned patent application is hereby incorporated by reference herein and made a part of this specification.

### BACKGROUND

### Technical Field

The disclosure relates to a display technology with a switchable viewing angle range. In particular, the disclosure relates to a viewing angle switching module and a display apparatus.

### Description of Related Art

Generally speaking, a display apparatus typically provides wide-viewing-angle for multiple viewers to watch it together. However, in some situations or occasions, for example, for browsing private webpages or confidential information, or entering passwords in public, the wide viewing angle display is likely peeped by others, resulting in leakage of confidential information. The general practice for anti-peeping is to place an anti-peeping sheet in front of a display panel to filter out light at a large viewing angle. However, such a practice may compromise the brightness and display quality of the display panel. Comparative, when anti-peeping is not required, the anti-peeping sheet is then manually removed from the display panel. In other words, although such an anti-peeping sheet achieves anti-peeping, there is still an improvement in the convenience of its operation and the anti-peeping display quality. Therefore, how to develop a display apparatus in which viewing angle switching is convenient and anti-peeping is also achieved has become an issue for related manufacturers.

### SUMMARY

The disclosure is directed to a viewing angle switching module, in which viewing angle switching and light energy utilization are improved.

The disclosure is directed to a display apparatus, in which anti-peeping and convenience of switching are improved.

According to an embodiment of the disclosure, a viewing angle switching module includes a first viewing angle controlling device, a second viewing angle controlling device, a first polarizer, and a second polarizer. The first viewing angle controlling device includes a first alignment layer, a second alignment layer, and a first liquid crystal layer. The first alignment layer and the second alignment layer respectively have a first alignment direction and a second alignment direction. The first alignment direction is anti-parallel to the second alignment direction. The first liquid crystal layer is sandwiched between the first alignment layer and the second alignment layer. The second viewing angle controlling device is overlapped with the first viewing angle controlling device, and includes a third alignment layer, a fourth alignment layer, and a second liquid crystal layer. The third alignment layer and the fourth alignment layer respectively have a third alignment direction and a fourth alignment direction. The third alignment direction is anti-parallel to the fourth alignment direction. The second liquid crystal layer is sandwiched between the third alignment layer and the fourth alignment layer. The first polarizer is disposed on a side of the first viewing angle controlling device and has a first absorption axis. The first alignment direction and the second alignment direction are perpendicular or parallel to an axial direction of the first absorption axis. The second polarizer is disposed on a side of the second viewing angle controlling device and has a second absorption axis. The third alignment direction and the fourth alignment direction are perpendicular or parallel to an axial direction of the second absorption axis.

In the viewing angle switching module according to an embodiment of the disclosure, the first viewing angle controlling device and the second viewing angle controlling device are located between the first polarizer and the second polarizer, and the axial direction of the first absorption axis is perpendicular to the axial direction of the second absorption axis.

In the viewing angle switching module according to an embodiment of the disclosure, the first viewing angle controlling device is located between the first polarizer and the second polarizer, the second polarizer is located between the first viewing angle controlling device and the second viewing angle controlling device, and the axial direction of the first absorption axis is parallel to the axial direction of the second absorption axis.

In the viewing angle switching module according to an embodiment of the disclosure, the axial direction of the first absorption axis is parallel to the axial direction of the second absorption axis, the first alignment direction and the second alignment direction are perpendicular to the axial direction of the first absorption axis, and the third alignment direction and the fourth alignment direction are parallel to the axial direction of the second absorption axis.

In the viewing angle switching module according to an embodiment of the disclosure, the first alignment direction is parallel to the third alignment direction, and the second alignment direction is parallel to the fourth alignment direction.

According to an embodiment of the disclosure, a display apparatus includes a display panel and a viewing angle switching module that are overlapped with each other. The viewing angle switching module includes a first viewing angle controlling device, a second viewing angle controlling device, a first polarizer, a second polarizer, and a third polarizer. The first viewing angle controlling device includes a first alignment layer, a second alignment layer, and a first liquid crystal layer. The first alignment layer and the second alignment layer respectively have a first alignment direction and a second alignment direction. The first alignment direction is anti-parallel to the second alignment direction. The first liquid crystal layer is sandwiched between the first alignment layer and the second alignment layer. The second viewing angle controlling device is overlapped with the first viewing angle controlling device and includes a third alignment layer, a fourth alignment layer, and a second liquid crystal layer. The third alignment layer and the fourth alignment layer respectively have a third alignment direction and a fourth alignment direction. The third alignment direction being anti-parallel to the fourth alignment direction. The second liquid crystal layer is sandwiched between the third alignment layer and the fourth alignment layer.

The first polarizer is disposed on a side of the first viewing angle controlling device away from the display panel and has a first absorption axis. The first alignment direction and the second alignment direction are perpendicular or parallel to an axial direction of the first absorption axis. The second polarizer is disposed between the display panel and the viewing angle switching module and has a second absorption axis. The axial direction of the first absorption axis is parallel to an axial direction of the second absorption axis. The third polarizer is disposed on a side of the second viewing angle controlling device and has a third absorption axis. The third alignment direction and the fourth alignment direction are perpendicular or parallel to an axial direction of the third absorption axis.

In the display apparatus according to an embodiment of the disclosure, the display panel is disposed between the first viewing angle controlling device and the second viewing angle controlling device. The first viewing angle controlling device and the second viewing angle controlling device are located between the first polarizer and the third polarizer, and the axial direction of the first absorption axis is perpendicular to the axial direction of the third absorption axis.

In the display apparatus according to an embodiment of the disclosure, a fourth polarizer is disposed between the second viewing angle controlling device and the display panel. The fourth polarizer has a fourth absorption axis, and an axial direction of the fourth absorption axis is parallel to the axial direction of the third absorption axis.

In the display apparatus according to an embodiment of the disclosure, the first viewing angle controlling device is located between the second viewing angle controlling device and the display panel. The first polarizer is located between the first viewing angle controlling device and the second viewing angle controlling device. The second polarizer is located between the display panel and the first viewing angle controlling device. The third polarizer is located on a side of the second viewing angle controlling device away from the first viewing angle controlling device. The axial direction of the first absorption axis is parallel to the axial direction of the second absorption axis and the axial direction of the third absorption axis.

In the display apparatus according to an embodiment of the disclosure, a fourth polarizer is disposed on a side of the display panel away from the first viewing angle controlling device and the second viewing angle controlling device. The fourth polarizer has a fourth absorption axis, and an axial direction of the fourth absorption axis is perpendicular to the axial direction of the second absorption axis.

In the display apparatus according to an embodiment of the disclosure, the axial direction of the first absorption axis is parallel to the axial direction of the third absorption axis. The first alignment direction and the second alignment direction are perpendicular to the axial direction of the first absorption axis, and the third alignment direction and the fourth alignment direction are parallel to the axial direction of the third absorption axis.

In the display apparatus according to an embodiment of the disclosure, the first alignment direction is parallel to the third alignment direction, and the second alignment direction is parallel to the fourth alignment direction.

Based on the foregoing, in the display apparatus according to an embodiment of the disclosure, the viewing angle switching module includes two viewing angle controlling devices. In each viewing angle controlling device, the liquid crystal layer is arranged by two alignment layers whose alignment directions are anti-parallel to each other. The alignment directions of the two liquid crystal layers in one viewing angle controlling device may be perpendicular or parallel to those in the other viewing angle controlling device. By overlapping the two viewing angle controlling devices, in addition to maintaining the overall brightness near the front viewing angle of the display panel, it is possible to realize the anti-peeping of the conventional anti-peeping sheet, and also improve the convenience of switching.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a schematic cross-sectional view of a display apparatus according to a first embodiment of the disclosure.

FIG. 2A is a schematic plan view of the relationship between axial directions of some film layers of the display apparatus of FIG. 1.

FIG. 2B is a schematic plan view of the relationship between axial directions of some film layers of the display apparatus according to another variant embodiment of FIG. 1.

FIG. 3A is a distribution diagram of the brightness of the display apparatus of FIG. 2A operated in an anti-peeping mode.

FIG. 3B is a distribution diagram of the brightness of the display apparatus of FIG. 2B operated in an anti-peeping mode.

FIG. 4 is a schematic cross-sectional view of a display apparatus according to a second embodiment of the disclosure.

FIG. 5 is a schematic plan view of the relationship between axial directions of some film layers of the display apparatus of FIG. 4.

FIG. 6 is a distribution diagram of the brightness of the display apparatus of FIG. 4 operated in an anti-peeping mode.

FIG. 7 is a schematic cross-sectional view of a display apparatus according to a third embodiment of the disclosure.

FIG. 8 is a schematic plan view of the relationship between axial directions of some film layers of the display apparatus of FIG. 7.

FIG. 9 is a distribution diagram of the brightness of the display apparatus of FIG. 7 operated in an anti-peeping mode.

FIG. 10 is a schematic cross-sectional view of a display apparatus according to a fourth embodiment of the disclosure.

FIG. 11 is a schematic cross-sectional view of a display apparatus according to a fifth embodiment of the disclosure.

### DESCRIPTION OF THE EMBODIMENTS

Reference will now be made in detail to exemplary embodiments of the disclosure, examples of which are illustrated in the accompanying drawings. Wherever possible, the same element reference numerals are used in the drawings and description to refer to the same or like parts.

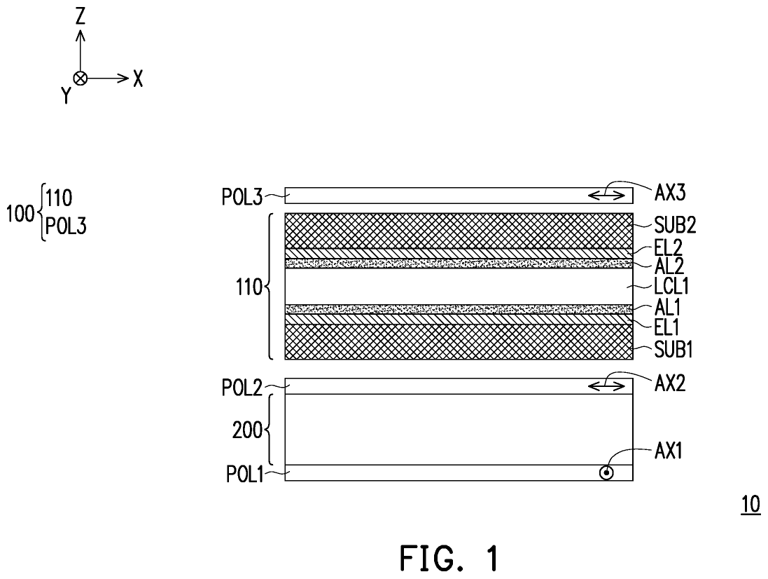

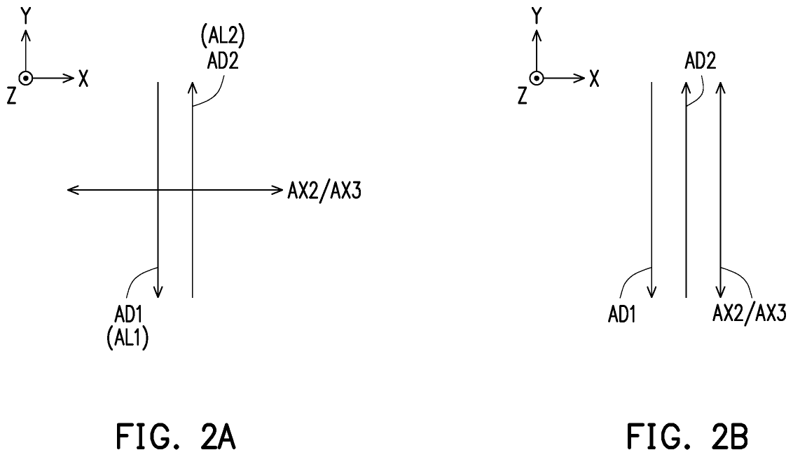

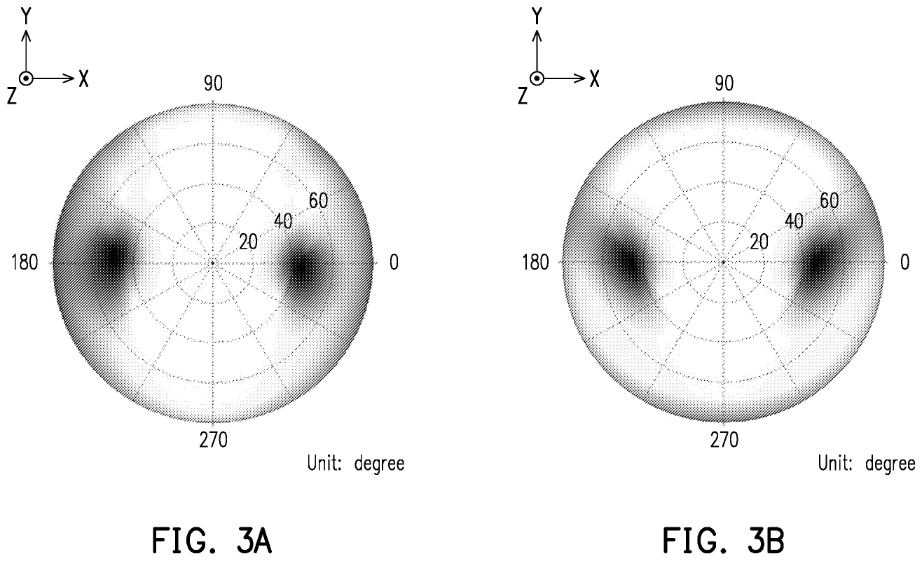

FIG. 1 is a schematic cross-sectional view of a display apparatus according to a first embodiment of the disclosure. FIG. 2A is a schematic plan view of the relationship between axial directions of some film layers of the display apparatus of FIG. 1 FIG. 2B is a schematic plan view of the relationship between axial directions of some film layers of the display apparatus according to another variant embodiment of FIG. 1. FIG. 3A is a distribution diagram of the brightness of the display apparatus of FIG. 2A operated in an anti-peeping mode. FIG. 3B is a distribution diagram of the brightness of the display apparatus of FIG. 2B operated in an anti-peeping mode.

With reference to FIG. 1 and FIG. 2A, a display apparatus 10 includes a viewing angle switching module 100 and a display panel 200 that are overlapped along the direction Z. In this embodiment, the display panel 200 may be a non-self-luminous display panel, for example, a liquid crystal display panel. Therefore, the display apparatus 10 may also be provided with a backlight module (not shown) to provide the required illumination light source for the display panel 200. In addition, for effective light modulation performance of the display panel 200, a polarizer POL1 and a polarizer POL2 may also be respectively disposed on opposite sides of the display panel 200, and the polarizer POL2 is located between the viewing angle switching module 100 and the display panel 200. In this embodiment, an axial direction of an absorption axis AX1 of the polarizer POL1 may be optionally perpendicular to an axial direction of an absorption axis AX2 of the polarizer POL2, but not limited thereto.

In other embodiments, the display panel 200 may also be a self-luminous display panel, for example, an organic light-emitting diode (OLED) display panel, a micro light-emitting diode (micro-LED) display panel, or a mini light-emitting diode (mini-LED) display panel.

The viewing angle switching module 100 includes a viewing angle controlling device 110. The viewing angle controlling device 110 includes a first substrate SUB1, a second substrate SUB2, a first liquid crystal layer LCL1, a first alignment layer AL1, a second alignment layer AL2, a first electrode layer EL1, and a second electrode layer EL2. The materials of the first substrate SUB1 and the second substrate SUB2 may include glass, quartz, high molecular polymers, or other suitable light-transmitting plates. The first liquid crystal layer LCL1 is disposed between the first substrate SUB1 and the second substrate SUB2. The first alignment layer AL1 is disposed between the first liquid crystal layer LCL1 and the first substrate SUB1. The second alignment layer AL2 is disposed between the first liquid crystal layer LCL1 and the second substrate SUB2. The first alignment layer AL1 and the second alignment layer AL2 are configured to align the first liquid crystal layer LCL1, and respectively have a first alignment direction AD1 and a second alignment direction AD2. The first alignment direction AD1 is anti-parallel to the second alignment direction AD2. In this embodiment, for example, the first alignment direction AD1 is the opposite direction to the direction Y, and the second alignment direction AD2 is the direction Y (as shown in FIG. 2A).

Specifically, the configuration of the viewing angle switching module 100 enables the display apparatus 10 to be anti-peeping. The alignment directions of the first alignment layer AL1 and the second alignment layer AL2 of the viewing angle controlling device 110 may define a direction for switching the viewing angle (i.e., the anti-peeping direction) of the display apparatus 10, and the viewing angle switching direction is substantially perpendicular to the alignment directions of the first alignment layer AL1 and the second alignment layer AL2, for example, the direction X of FIG. 2A. In this embodiment, the display apparatus 10 may switch between a non-anti-peeping mode and an anti-peeping mode according to whether the viewing angle controlling device 110 is enabled or not. For example, the display apparatus 10 is operated in the anti-peeping mode when the viewing angle controlling device 110 is enabled, and the display apparatus 10 is operated in the non-anti-peeping mode when the viewing angle controlling device 110 is disabled, but not limited thereto.

The first electrode layer EL1 is disposed between the first substrate SUB1 and the first alignment layer AL1. The second electrode layer EL2 is disposed between the second substrate SUB2 and the second alignment layer AL2. For example, in this embodiment, the first electrode layer EL1 and the second electrode layer EL2 may be whole-surface electrodes or patterned electrodes, which is not limited by the disclosure. The first electrode layer EL1 and the second electrode layer EL2 are light-transmissive electrodes, for example. The material of the light-transmissive electrodes may include metal oxides, such as indium tin oxide, indium zinc oxide, aluminum tin oxide, aluminum zinc oxide, or other suitable oxides, or a stacked layer of at least two of the above.

When the viewing angle controlling device 110 is enabled, the first electrode layer EL1 and the second electrode layer EL2 are respectively applied with different potentials to form an electric field between the two electrode layers for driving liquid crystal molecules (not shown) of the first liquid crystal layer LCL1 to be rotated. In other words, the viewing angle controlling device 110 of this embodiment is an electronically controlled liquid crystal cell.

In this embodiment, the viewing angle switching module 100 further includes a polarizer POL3 disposed on a side of the viewing angle controlling device 110 away from the display panel 200. An axial direction of an absorption axis AX3 of the polarizer POL3 is parallel to the axial direction of the absorption axis AX2 of the polarizer POL2 disposed adjacent to the other side of the viewing angle controlling device 110, and perpendicular to the alignment directions of the first alignment layer AL1 and the second alignment layer AL2. In other words, the axial directions of the respective absorption axes of the polarizer POL2 and the polarizer POL3 of this embodiment are configured in the direction X, but not limited thereto. In another variant embodiment, the axial directions of the respective absorption axes of the polarizer POL2 and the polarizer POL3 may also be parallel to the alignment directions of the first alignment layer AL1 and the second alignment layer AL2 (as shown in FIG. 2B).

With reference to FIG. 3A together, when the viewing angle controlling device 110 is enabled, the display apparatus 10 may be anti-peeping in the horizontal dimension of FIG. 3A (i.e., at the azimuth angles of 0 degree and 180 degrees). For example, the light emission brightness of the display apparatus 10 within the viewing angle range of 40 degrees to 60 degrees can be significantly suppressed. Comparatively, the display apparatus 10 is not anti-peeping in the vertical dimension of FIG. 3A (i.e., at the azimuth angles of 90 degrees and 270 degrees). In the variant embodiment of FIG. 2B, although the axial directions of the absorption axis AX2 and the absorption axis AX3 of the two polarizers are parallel to the alignment directions of the two alignment layers of the viewing angle switching module, the display apparatus can also be anti-peeping similarly to this embodiment, as shown in FIG. 3B.

By disposing the viewing angle switching module 100, the display apparatus 10 can not only realize anti-peeping of the conventional privacy protection sheet, but also prevent the light emission brightness of the display panel 200 from attenuation due to the privacy protection sheet currently disposed. In addition, the property of electronically controlled switching of the viewing angle controlling device 110 can also improve the convenience of switching between the non-anti-peeping mode and the anti-peeping mode of the display apparatus 10.

The disclosure will be described in detail in some other embodiments below, where the same members will be labeled with the same reference numerals, and description of the same technical content will be omitted. Reference may be made to the embodiments above for the omitted part, which will not be repeatedly described here.

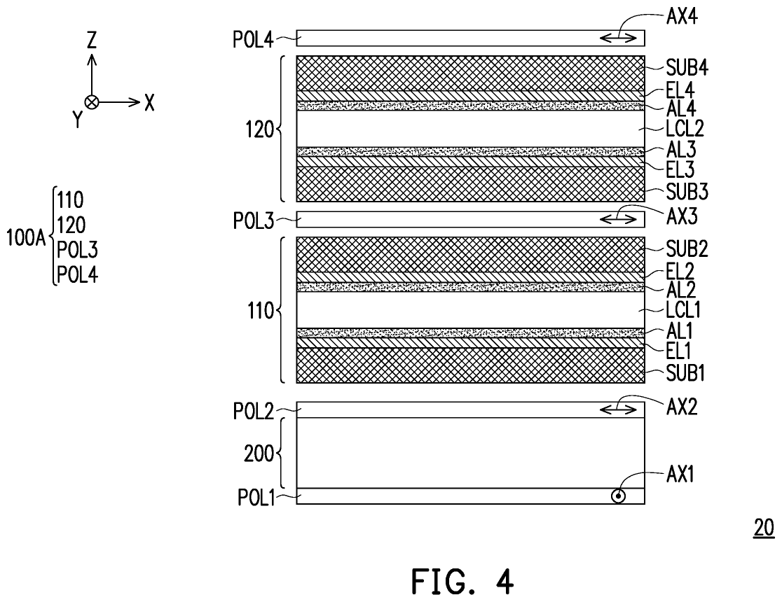

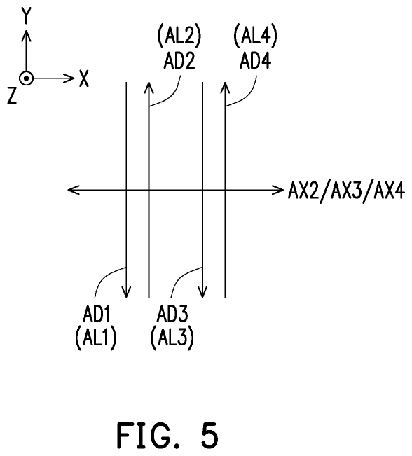

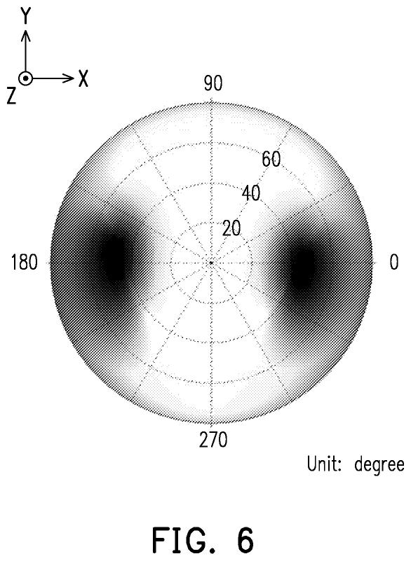

FIG. 4 is a schematic cross-sectional view of a display apparatus according to a second embodiment of the disclosure. FIG. 5 is a schematic plan view of the relationship between axial directions of some film layers of the display apparatus of FIG. 4. FIG. 6 is a distribution diagram of the brightness of the display apparatus of FIG. 4 operated in an anti-peeping mode.

With reference to FIG. 4 and FIG. 5, the main difference between a display apparatus 20 of this embodiment and the display apparatus 10 of FIG. 1 is the number of viewing angle controlling devices of the viewing angle switching module. Specifically, to further improve the anti-peeping of the display apparatus 20 compared with the display apparatus 10 of FIG. 1, a viewing angle switching module 100A of the display apparatus 20 further includes another viewing angle controlling device 120. In this embodiment, the viewing angle controlling device 120 and the viewing angle controlling device 110 are overlapped along the direction Z, and are located on the side of the viewing angle controlling device 110 away from the display panel 200.

Similar to the viewing angle controlling device 110, the viewing angle controlling device 120 may include a third substrate SUB3, a fourth substrate SUB4, a second liquid crystal layer LCL2, a third alignment layer AL3, a fourth alignment layer AL4, a third electrode layer EL3, and a fourth electrode layer EL4. The materials of the third substrate SUB3 and the fourth substrate SUB4 may include glass, quartz, high molecular polymers, or other suitable light-transmitting plates. The second liquid crystal layer LCL2 is disposed between the third substrate SUB3 and the fourth substrate SUB4. The third alignment layer AL3 is disposed between the second liquid crystal layer LCL2 and the third substrate SUB3. The fourth alignment layer AL4 is disposed between the second liquid crystal layer LCL2 and the fourth substrate SUB4. The third alignment layer AL3 and the fourth alignment layer AL4 are configured to align the second liquid crystal layer LCL2, and respectively have a third alignment direction AD3 and a fourth alignment direction AD4. The third alignment direction AD3 is anti-parallel to the fourth alignment direction AD4. In this embodiment, for example, the third alignment direction AD3 is the opposite direction to the direction Y, and the fourth alignment direction AD4 is the direction Y (as shown in FIG. 5).

In this embodiment, the third alignment direction AD3 of the third alignment layer AL3 and the fourth alignment direction AD4 of the fourth alignment layer AL4 of the viewing angle controlling device 120 are parallel to the first alignment direction AD1 of the first alignment layer AL1 and the second alignment direction AD2 of the second alignment layer AL2 of the viewing angle controlling device 110, and perpendicular to the axial directions of the respective absorption axes of the polarizer POL2 and the polarizer POL3. For example, the first alignment direction AD1 may be parallel to the third alignment direction AD3, and the second alignment direction AD2 may be parallel to the fourth alignment direction AD4, but not limited thereto.

The third electrode layer EL3 is disposed between the third substrate SUB3 and the third alignment layer AL3. The fourth electrode layer EL4 is disposed between the fourth substrate SUB4 and the fourth alignment layer AL4. For example, in this embodiment, the third electrode layer EL3 and the fourth electrode layer EL4 may be whole-surface electrodes or patterned electrodes, which is not limited by the disclosure. The third electrode layer EL3 and the fourth electrode layer EL4 are light-transmissive electrodes, for example. The material of the light-transmissive electrodes may include metal oxides, such as indium tin oxide, indium zinc oxide, aluminum tin oxide, aluminum zinc oxide, or other suitable oxides, or a stacked layer of at least two of the above.

When the viewing angle controlling device 120 is enabled, the third electrode layer EL3 and the fourth electrode layer EL4 are respectively applied with different potentials to form an electric field between the two electrode layers for driving liquid crystal molecules (not shown) of the second liquid crystal layer LCL2 to be rotated. In other words, the viewing angle controlling device 120 of this embodiment is an electronically controlled liquid crystal cell.

In this embodiment, the viewing angle switching module 100A of the display apparatus further includes a polarizer POL4 disposed on a side of the viewing angle controlling device 120 away from the viewing angle controlling device 110. An axial direction of an absorption axis AX4 of the polarizer POL4 is parallel to the axial direction of the absorption axis AX3 of the polarizer POL3 disposed adjacent to the other side of the viewing angle controlling device 120, and perpendicular to the alignment directions of the third alignment layer AL3 and the fourth alignment layer AL4. In other words, the axial directions of the respective absorption axes of the polarizer POL2, the polarizer POL3, and the polarizer POL4 of this embodiment is configured in the direction X, but not limited thereto.

With reference to FIG. 6 together, when the display apparatus 20 is operated in an anti-peeping mode, the viewing angle controlling device 110 and the viewing angle controlling device 120 may both be enabled such that the display apparatus 20 is anti-peeping in the horizontal dimension of FIG. 6 (i.e., at the azimuth angles of 0 degree and 180 degrees). For example, the light emission brightness of the display apparatus 20 within the viewing angle range of 30 degrees to 60 degrees can be suppressed more significantly compared with the display apparatus 10 of FIG. 1.

In this embodiment, since two viewing angle controlling devices are overlapped on the display panel 200, when both viewing angle controlling devices are enabled, the display apparatus can also be effectively anti-peeping in adjacent directions deviated from the azimuth angles of 0 degree and 180 degrees. In other words, the anti-peeping range of the display apparatus 20 of this embodiment can be further expanded compared with the display apparatus 10 of FIG. 1.

When the display apparatus 20 is operated in the anti-peeping mode, it is also possible that only one of the viewing angle controlling device 110 and the viewing angle controlling device 120 is enabled, so that the display apparatus 20 is anti-peeping similarly to the display apparatus of FIG. 1.

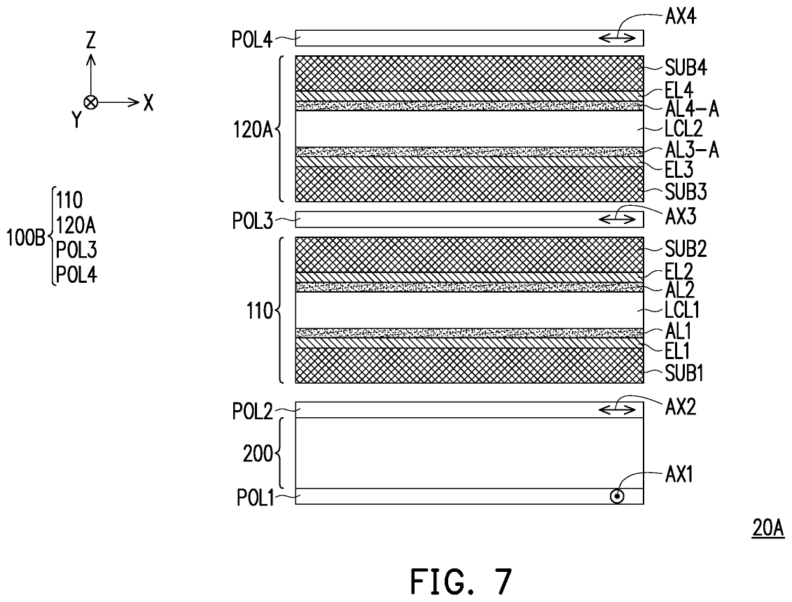

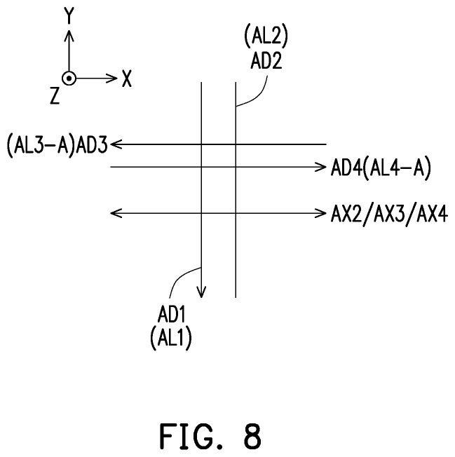

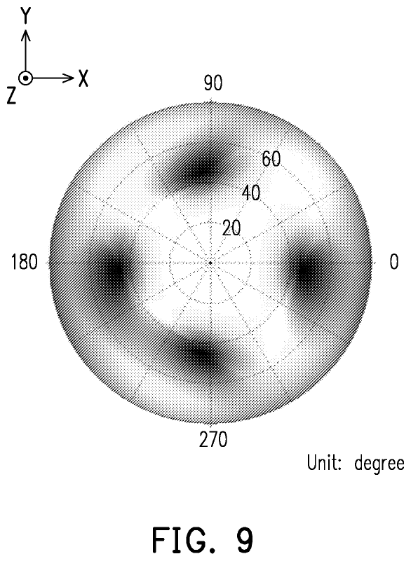

FIG. 7 is a schematic cross-sectional view of a display apparatus according to a third embodiment of the disclosure. FIG. 8 is a schematic plan view of the relationship between axial directions of some film layers of the display apparatus of FIG. 7. FIG. 9 is a distribution diagram of the brightness of the display apparatus of FIG. 7 operated in an anti-peeping mode. With reference to FIG. 7 and FIG. 8, the difference between a display apparatus 20A of this embodiment and the display apparatus 20 of FIG. 4 is that an alignment direction of an alignment layer of a viewing angle controlling device 120A is different from the alignment direction of the alignment layer of the viewing angle controlling device 120.

In this embodiment, in a viewing angle switching module 100B, the third alignment direction AD3 of a third alignment layer AL3-A and the fourth alignment direction AD4 of a fourth alignment layer AL4-A the viewing angle controlling device 120A are perpendicular to the first alignment direction AD1 of the first alignment layer AL1 and the second alignment direction AD2 of the second alignment layer AL2 of the viewing angle controlling device 110, and parallel to the axial directions of the respective absorption axes of the polarizer POL2, the polarizer POL3, and the polarizer POL4. In this embodiment, for example, the third alignment direction AD3 is the opposite direction to the direction X, and the fourth alignment direction AD4 is the direction X (as shown in FIG. 8).

With reference to FIG. 9 together, since the alignment directions of the two alignment layers of the viewing angle controlling device 120A are substantially perpendicular to the alignment directions of the two alignment layers of the viewing angle controlling device 110, the display apparatus 20A can also be anti-peeping in the vertical dimension of FIG. 9 (i.e., at the azimuth angles of 90 degrees and 270 degrees). In other words, the display apparatus 20A of this embodiment can switch the viewing angle to both the horizontal dimension and the vertical dimension. Therefore, the operation mode of the display apparatus 20A can be relatively flexible. For example, the display apparatus 20A may be operated in three anti-peeping modes as follows. When the viewing angle controlling device 110 is enabled and the viewing angle controlling device 120A is not enabled, the display apparatus 20A is anti-peeping in the horizontal dimension. When the viewing angle controlling device 120A is enabled and the viewing angle controlling device 110 is not enabled, the display apparatus 20A is anti-peeping in the vertical dimension. When both viewing angle controlling devices are enabled, the display apparatus 20A is anti-peeping in both the horizontal dimension and the vertical dimension.

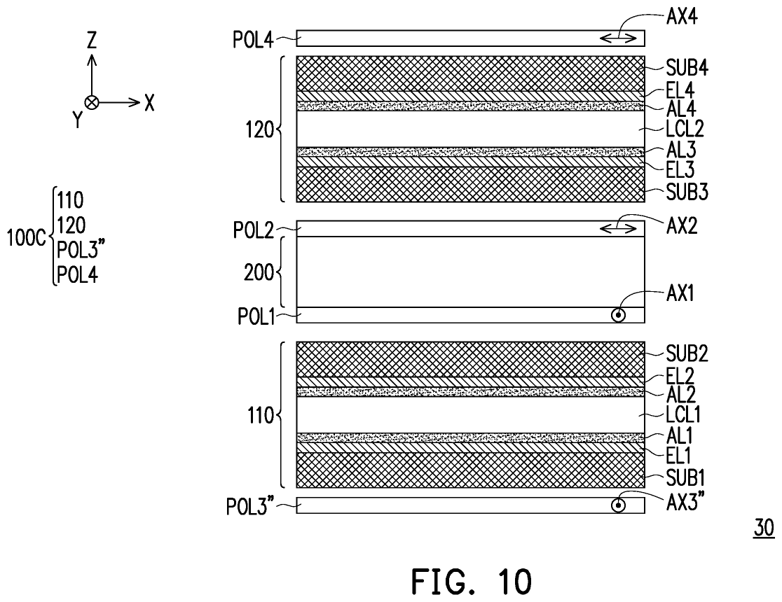

FIG. 10 is a schematic cross-sectional view of a display apparatus according to a fourth embodiment of the disclosure. With reference to FIG. 10, the main difference between a display apparatus 30 of this embodiment and the display apparatus 20 of FIG. 4 is that the display panel and the viewing angle controlling device are overlapped in a different sequence. In this embodiment, the display panel 200 of the display apparatus 30 is disposed between the viewing angle controlling device 110 and the viewing angle controlling device 120 of a viewing angle switching module 100C, and a polarizer POL3″ is disposed on the side of the viewing angle controlling device 110 away from the display panel 200. An axial direction of an absorption axis AX3″ of the polarizer POL3″ is parallel to the axial direction of the absorption axis AX1 of the polarizer POL1 disposed adjacent to the other side of the viewing angle controlling device 110.

Since the viewing angle switching module 100C of this embodiment achieves anti-peeping for the display panel 200 similarly to the display apparatus 20 of the embodiment of FIG. 4, reference may be made to the relevant paragraphs of the embodiments above for the detailed description, which will not be repeated here.

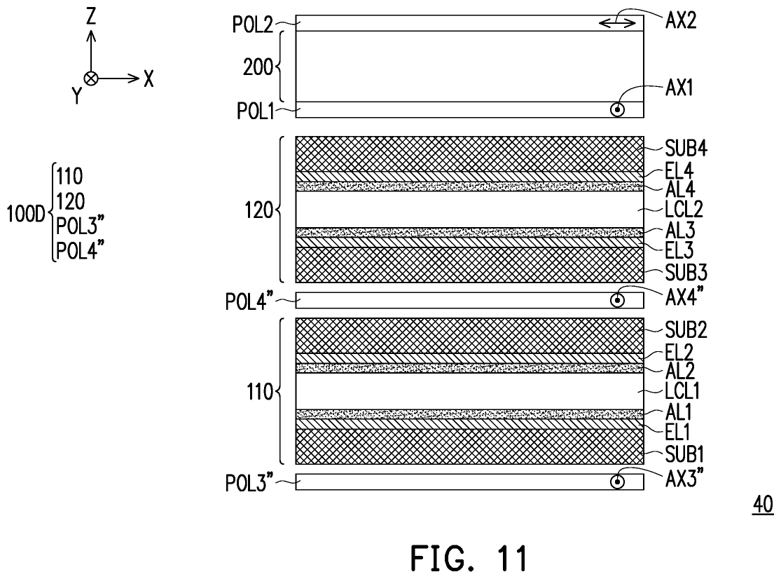

FIG. 11 is a schematic cross-sectional view of a display apparatus according to a fifth embodiment of the disclosure. With reference to FIG. 11, the difference between a display apparatus 40 of this embodiment and the display apparatus 30 of FIG. 10 is that the display panel and the viewing angle controlling device are overlapped in a different sequence. In this embodiment, the display panel 200 of the display apparatus 40 is disposed above a viewing angle switching module 100D, the viewing angle controlling device 120 is located between the display panel 200 and the viewing angle controlling device 110, and a polarizer POL4″ is disposed between the viewing angle controlling device 110 and the viewing angle controlling device 120. An axial direction of an absorption axis AX4″ of the polarizer POL4″ is parallel to the axial direction of the absorption axis AX1 of the polarizer POL1 and the axial direction of the absorption axis AX3″ of the polarizer POL3″, and perpendicular to the axial direction of the absorption axis AX2 of the polarizer POL2. Since the viewing angle switching module 100D of this embodiment achieves anti-peeping for the display panel 200 similarly to the display apparatus 20 of the embodiment of FIG. 4, reference may be made to the relevant paragraphs of the embodiments above for the detailed description, which will not be repeated here.

In summary of the foregoing, in the display apparatus according to an embodiment of the disclosure, the viewing angle switching module includes two viewing angle controlling devices. In each viewing angle controlling device, the liquid crystal layer is arranged by two alignment layers whose alignment directions are anti-parallel to each other. The alignment directions of the two liquid crystal layers in one viewing angle controlling device may be perpendicular or parallel to those in the other viewing angle controlling device. By overlapping the two viewing angle controlling devices, in addition to maintaining the overall brightness near the front viewing angle of the display panel, it is possible to realize the anti-peeping of the conventional anti-peeping sheet, and also improve the convenience of switching.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

1. A viewing angle switching module comprising:
a first viewing angle controlling device comprising:
a first alignment layer and a second alignment layer respectively having a first alignment direction and a second alignment direction, the first alignment direction being anti-parallel to the second alignment direction; and
a first liquid crystal layer sandwiched between the first alignment layer and the second alignment layer;
a second viewing angle controlling device overlapped with the first viewing angle controlling device and comprising:
a third alignment layer and a fourth alignment layer respectively having a third alignment direction and a fourth alignment direction, the third alignment direction being anti-parallel to the fourth alignment direction; and
a second liquid crystal layer sandwiched between the third alignment layer and the fourth alignment layer;
a first polarizer disposed on a side of the first viewing angle controlling device and having a first absorption axis, wherein the first alignment direction and the second alignment direction are perpendicular or parallel to an axial direction of the first absorption axis; and
a second polarizer disposed on a side of the second viewing angle controlling device and having a second absorption axis, wherein the third alignment direction and the fourth alignment direction are perpendicular or parallel to an axial direction of the second absorption axis, the first viewing angle controlling device and the second viewing angle controlling device are located between the first polarizer and the second polarizer, the axial direction of the first absorption axis is parallel to the axial direction of the second absorption axis, the first alignment direction and the second alignment direction are perpendicular to the axial direction of the first absorption axis, and the third alignment direction and the fourth alignment direction are parallel to the axial direction of the second absorption axis.

2. The viewing angle switching module according to claim 1, wherein the first viewing angle controlling device and the second viewing angle controlling device are located between the first polarizer and the second polarizer, and the axial direction of the first absorption axis is perpendicular to the axial direction of the second absorption axis.

3. The viewing angle switching module according to claim 1, wherein the first viewing angle controlling device is located between the first polarizer and the second polarizer, the second polarizer is located between the first viewing angle controlling device and the second viewing angle controlling device, and the axial direction of the first absorption axis is parallel to the axial direction of the second absorption axis.

4. (canceled)

5. The viewing angle switching module according to claim 1, wherein the first alignment direction is parallel to the third alignment direction, and the second alignment direction is parallel to the fourth alignment direction.

6. A display apparatus, comprising:
a display panel; and
a viewing angle switching module overlapped with the display panel and comprising:
a first viewing angle controlling device comprising:
a first alignment layer and a second alignment layer respectively having a first alignment direction and a second alignment direction, the first alignment direction being anti-parallel to the second alignment direction; and
a first liquid crystal layer sandwiched between the first alignment layer and the second alignment layer;
a second viewing angle controlling device overlapped with the first viewing angle controlling device and comprising:
a third alignment layer and a fourth alignment layer respectively having a third alignment direction and a fourth alignment direction, the third alignment direction being anti-parallel to the fourth alignment direction; and
a second liquid crystal layer sandwiched between the third alignment layer and the fourth alignment layer;
a first polarizer disposed on a side of the first viewing angle controlling device away from the display panel and having a first absorption axis, wherein the first alignment direction and the second alignment direction are perpendicular or parallel to an axial direction of the first absorption axis;
a second polarizer disposed between the display panel and the viewing angle switching module and having a second absorption axis, wherein the axial direction of the first absorption axis is parallel to an axial direction of the second absorption axis, the first viewing angle controlling device and the second viewing angle controlling device are located between the first polarizer and the second polarizer, the axial direction of the first absorption axis is parallel to the axial direction of the second absorption axis, the first alignment direction and the second alignment direction are perpendicular to the axial direction of the first absorption axis, and the third alignment direction and the fourth alignment direction are parallel to the axial direction of the second absorption axis; and
a third polarizer disposed on a side of the second viewing angle controlling device and having a third absorption axis, wherein the third alignment direction and the fourth alignment direction are perpendicular or parallel to an axial direction of the third absorption axis.

7. The display apparatus according to claim 6, wherein the display panel is disposed between the first viewing angle controlling device and the second viewing angle controlling device, the first viewing angle controlling device and the second viewing angle controlling device are located between the first polarizer and the third polarizer, and the axial direction of the first absorption axis is perpendicular to the axial direction of the third absorption axis.

8. The display apparatus according to claim 7, wherein a fourth polarizer is disposed between the second viewing angle controlling device and the display panel, the fourth polarizer has a fourth absorption axis, and an axial direction of the fourth absorption axis is parallel to the axial direction of the third absorption axis.

9. The display apparatus according to claim 6, wherein the first viewing angle controlling device is located between the second viewing angle controlling device and the display panel, the first polarizer is located between the first viewing angle controlling device and the second viewing angle controlling device, the second polarizer is located between the display panel and the first viewing angle controlling device, the third polarizer is located on a side of the second viewing angle controlling device away from the first viewing angle controlling device, and the axial direction of the first absorption axis is parallel to the axial direction of the second absorption axis and the axial direction of the third absorption axis.

10. The display apparatus according to claim 9, wherein a fourth polarizer is disposed on a side of the display panel away from the first viewing angle controlling device and the second viewing angle controlling device, the fourth polarizer has a fourth absorption axis, and an axial direction of the fourth absorption axis is perpendicular to the axial direction of the second absorption axis.

11. The display apparatus according to claim 6, wherein the axial direction of the first absorption axis is parallel to the axial direction of the third absorption axis, the first alignment direction and the second alignment direction are perpendicular to the axial direction of the first absorption axis, and the third alignment direction and the fourth alignment direction are parallel to the axial direction of the third absorption axis.

12. The display apparatus according to claim 6, wherein the first alignment direction is parallel to the third alignment direction, and the second alignment direction is parallel to the fourth alignment direction.
